(19) United States
(12) Patent Application Publication
(10) Pub. No.: US 2010/0100206 A1
(43) Pub. Date: Apr. 22, 2010

(54) Method and apparatus for wirelessly transferring music and other audio content to a car stereo or home stereo

(76) Inventor: Robert Khedouri, Roslyn, NY (US)

Correspondence Address: SOFER & HAROUN LLP., 317 MADISON AVENUE, SUITE 910, NEW YORK, NY, 10017, US

(21) Appl. No.: 12/386,060

(22) Filed: Apr. 13, 2009

Related U.S. Application Data
(63) Continuation of application No. 10/883,031, filed on Jul. 1, 2004, now abandoned.
(60) Provisional application No. 60/484,332, filed on Jul. 1, 2003.

(51) Int. Cl. G06F 17/00

(52) U.S. Cl. 700/94

(57) ABSTRACT

A system for playing audio files comprised of an audio device for storing and playing audio files and a transmitter device, coupled to the audio device for receiving audio signals from the audio device and converting them into a wireless audio signal. A receiving device is also provided, configured to receive the wireless audio signal and coverts it back to the audio signal, where the receiving device is further arranged to couple with a preexisting audio playback device such that the audio signal can be played through the speakers of preexisting audio device.

This application is a continuation of U.S. patent application Ser. No. 10/883,031, filed on Jul. 1, 2004 which in turn claims the benefit of priority from U.S. Provisional Patent Application No. 60/484,332, filed on Jul. 1, 2003, the entirety of which are incorporated herein by reference.

### FIELD OF THE INVENTION

This invention relates to a method for distributing audio content. More particularly, the present invention is directed to a method for wirelessly distributing audio content through a preexisting audio playback system.

### BACKGROUND OF THE INVENTION

In recent years, in addition to many other portable and non-portable audio playback devices that have become available to consumers, so-called “MP3” players and other devices that store and playback audio content digitally have become common among consumers. Users commonly listen to music and other audio content on these devices through headphones, or in some cases by plugging a wire into the playback device that connects to another output device, such as a home stereo. Users have not commonly achieved a simple way to listen to their digital audio stored on these devices in their cars and other listening environments.

One early method was to plug the output of the stored audio content into a cassette housing which is in turn coupled to a standard cassette playback system. For example, U.S. Pat. No. 4,734,897 describes a device that enables this to occur, but suffers from certain drawbacks, including the need to have a physical wire connected to both the cassette-shaped device and the audio playback device, tethering the playback device to an area quite near the cassette deck and creating inconvenience for the user.

Another method that has been used is to transmit the stored audio content by to nearby radio using FM or AM radio frequencies. However, radio interference is common in many environments, leading to poor transmission quality and, consequently poor sound quality.

### OBJECT AND SUMMARY OF THE INVENTION

In order to overcome the drawbacks associated with the prior art, the present invention permits a user to place a simple cassette-shaped device in the cassette deck of a car or home stereo or other device and to transmit music and other audio content to the device for listening through the speakers (or other output) connected to the cassette deck.

The present invention utilizes a wireless cassette-shaped device that enables users to play music and other audio through the cassette deck and output device, enabling users to control and operate the audio playback device more conveniently and from a further distance away from the cassette deck than is currently possible. It also enables users to use the present invention where a wire-based version would not work, such as a cassette player that does not operate when a wire prevents the cassette deck door from closing properly.

The present invention further provides a method of powering a wireless circuit by utilizing the rotating drive spindles on a standard cassette deck to provide physical energy to a small electrical dynamo located in the cassette-shaped housing of the receiving device. The electricity generated is used to power the circuitry of the receiver, including the wireless circuitry located in the receiver's cassette-shaped housing.

The present invention also enables multiple users in a single room or a car to operate playback devices (potentially portable digital audio devices) and alternate turns in playing and controlling music and other audio that emanates from speakers (or other output) connected to the tape deck, without plugging and unplugging any wire.

To this end the present invention provides for a system and method for wirelessly transmitting music and other audio content from a portable or other audio player to car or home stereo. The present invention preferably includes: (a) a cassette-shaped housing that is insertable into the cassette deck of a cassette player; (b) a digital or analog wireless receiver or transceiver, such as Bluetooth, 802.11, RF, or another wireless technology now existing or later developable, included in the housing; (c) a digital audio decoding and processing chip or analog processing chip; (d) a power dynamo that delivers power to the electronic components in the cassette housing by converting the mechanical energy of the spinning spindles in the cassette deck to electrical energy, included in the housing, or alternatively a disposable or rechargeable battery; (e) an emulator in the housing, operatively communicating with the audio chip for emulating the audio information as analog audio information readable by the magnetic playing head of the cassette player for playing the audio information through the cassette player; and (f) a separate transmitting device that is capable of connecting to digital or analog outputs of audio players, such as a portable “MP3” player, compact disc (“CD”) player, FM radio, or other such devices, converting the audio output of such device into a form that can be wirelessly transmitted to and properly interpreted by the wireless receiver (or transceiver) (such as via Bluetooth, 802.11, or other wireless technologies), in a compressed or uncompressed digital format or in an analog format, and wirelessly transmitting (or transceiving) such a signal to the wireless receiver (or transceiver) in the cassette housing.

It is another object of the present invention, to allow for the recording of audio files onto an audio device directly from a preexisting audio device. As such, audio content heard on the preexisting audio device may be transmitted wireless via the present invention back to the audio device to be stored for later playback.

### BRIEF DESCRIPTION OF THE DRAWINGS

The objects and advantages of the integrated entertainment device network of the present invention will be readily apparent from the reading of the following detailed description of the device constructed in accordance with the invention by reference to the accompanying drawings thereof wherein:

FIG. 1 is a top view of an audio storage and playback device, in accordance with one embodiment of the present invention;

FIG. 2 is a top view of a wireless transceiver, in accordance with one embodiment of the present invention;

FIG. 3 is a front view of a cassette housing, in accordance with one embodiment of the present invention; and

FIG. 4 is a schematic diagram of the components of the audio playback system in accordance with one embodiment of the present invention.

### DETAILED DESCRIPTION

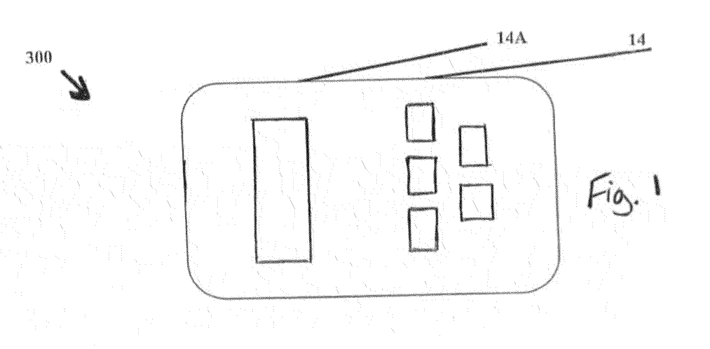

Referring now to the drawings wherein like references characters represent like and corresponding parts throughout the several views, there is illustrated in FIG. 1 an audio device 300 such as a portable CD/MP3 disc player or an MP3 player. It is noted that standard MP3 players and even some CD/MP3 disc devices are capable of both recording/burning and playback, as desired by the user. Audio device 300 maintains analog audio connector 14 (line out), and digital audio connector 14A.

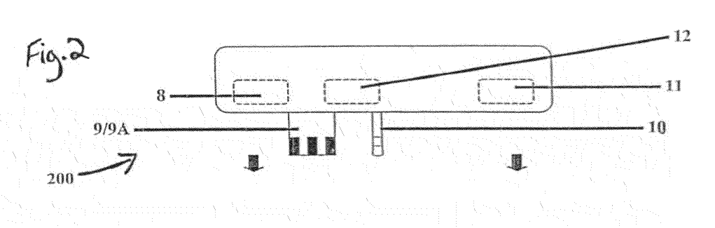

As illustrated in FIG. 2 a wireless transmitting device 200 is configured to be attached to audio device 300. Although device 200 is referred to as a transmitting device, the device may alternatively be a transceiving device. Similarly, all references throughout the application to either receiving devices or transmitting devices also are understood to alternatively maintain transceiving functions as well.

While transmitting and receiving may be sufficient for operation of the invention using an analog wireless technology, transceiving may be required in both cases for use of a digital wireless standard, such as 802.11, and is also required for all wireless recording functions to audio device 300.

Output from audio device 300 to transmitting device 200 can be either in analog or digital form. If the output is analog, it can be delivered via a standard 3.5 mm or ¼ inch connection plug 10, illustrated in FIG. 2, which is inserted into analog audio connector 14 on audio device 300. Alternatively, audio device 300 can output audio signals in compressed or uncompressed digital format from digital audio connector 14A to transmitting device 200. This can be achieved in multiple ways, including a USB or firewire (“1394”) output from the audio device or via wireless means (e.g., Bluetooth, 802.11, RF).

FIG. 2 shows a plug 9/9A located on transmitting device 200 compatible with digital connector 14A of device 300, capable of providing digital audio output to transmitting device 200. Plug 9/9A may also be used to deliver power from audio device 300 to transmitting device 200.

Alternatively, transmitting device 200 may be powered by using a disposable or rechargeable battery. A power transformer and regulator 8 may be necessary to deliver appropriate electrical power levels to the circuitry of transmitting device 200. Alternatively, a preferred embodiment of the invention includes the circuitry and components of transmitting device 200 built directly into audio device 300 so as to avoid the need for a separate external device connected to the audio device.

As a further alternative, a device with audio playing capabilities that has a wireless means (e.g., 802.11, Bluetooth, RF) can substitute for transmitting device 200. For example, such devices include wireless personal digital assistants such as the Compaq iPaq that has the necessary software to enable a wireless connection directly to other devices.

As illustrated in FIG. 2, in transmitter device 200, digital or analog audio is processed by audio processor/codec 12, including modifying the audio signal as may be needed for wireless transmission. Optionally, audio processor/codec 12 can also do any or all of the following tasks: (a) convert analog audio signals to digital signals; (b) compress digital audio information; (c) uncompress digital audio information; (d) provide audio enhancement to the audio signal; or (e) convert the audio signal to a signal that is more efficiently or effectively transmitted by wireless circuitry 11 in transmitting device 200.

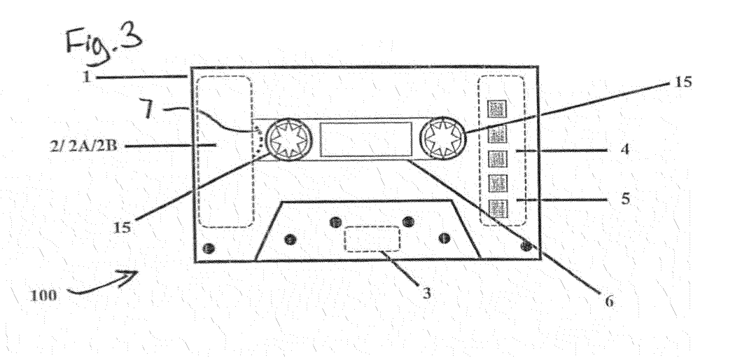

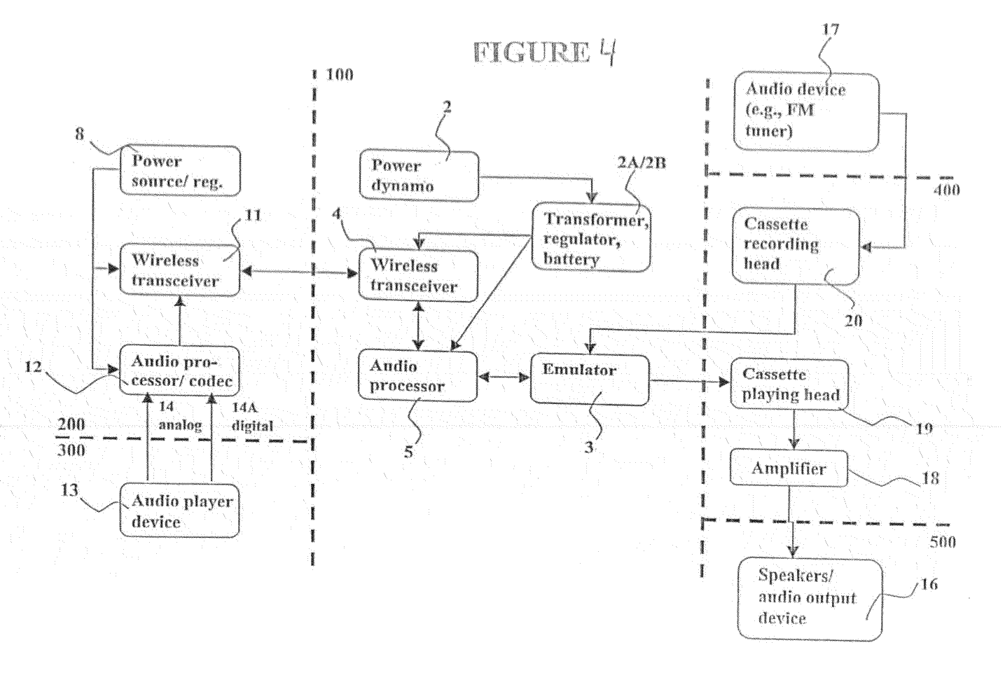

As illustrated in FIG. 3, wireless circuitry 11 of transmitting device 200 transmits the audio signal to a receiving device 100. Receiving device 100 has a housing unit 1 that is in the shape of a standard audio cassette that can be inserted into a cassette deck 400 of standard audio cassette players, illustrated schematically in FIG. 4. Housing unit 1 includes a place to accommodate the drive spindles, capstans, pinch rollers, guide pins and other standard cassette elements.

The purpose of power dynamo unit 2/2A/2B is to generate, transform, regulate and provide power to the circuitry of receiving device 100. The development and operation of dynamos that produce electricity by transforming physical rotation of an object is well known. A preferred embodiment of power dynamo unit 2/2A/2B includes a rechargeable battery or power cell to enable power generated by power dynamo unit 2/2A/2B to be stored and accumulated in receiving device 100.

Alternatively, receiving device 100 is powered by a disposable or rechargeable battery (not shown) located in receiving device 100 inside cassette-shaped housing 1.

When using power dynamo unit 2/2A/2B as a means to provide power, in order to generate power, receiving device 100 is inserted into a standard cassette deck 400, illustrated schematically on FIG. 4, and the play function of the cassette deck is engaged. If the cassette deck is operating properly and powered, the spindles engage in the inner sprockets of reels 15 located in cassette housing 1 and are rotated.

Reels 15 of the device are connected by means of a continuous belt 6, which may be made of rubber or any other acceptable material. The reels are further connected to rotating wheel located in power dynamo unit 2/2A/2B that forms a part of receiving device 100 in the preferred embodiment.

The connection to the wheel located in power dynamo unit 2/2A/2B can be accomplished in multiple ways, including by using a mechanism comprised of two toothed sprockets, one located on the reel located in power dynamo unit 2/2A/2B and the other located on the closer of two reels 15 mounted into cassette-shaped housing 1 of receiving device 100.

Alternatively, as illustrated in FIG. 3, the connection is depicted as being achieved by means of a second continuous belt 7 connected to one of reels 15 mounted into cassette-shaped housing 1 and the other to the reel or sprocket located in power dynamo unit 2/2A/2B.

In yet another alternative, power dynamo unit 2/2A/2B can be configured such that the spindle of the cassette deck 400 directly engages its wheel by positioning power dynamo unit 2/2A/2B around one or both of the reels 15. In that case, the wheel inside the power dynamo unit 2/2A/2B would have teeth along its inside surface so that the teeth engaged properly with the cassette spindle and the teeth on the wheel make it look like a standard cassette reel 15.

Accordingly, once receiving device 100 obtains electrical power delivered either from power dynamo unit 2/2A/2B or another appropriate power source, electrical power is delivered to wireless circuitry 4 of receiving device 100. Depending on the type of wireless technology being deployed, wireless circuitry 4 of receiving device 100 can either be a receiver or a transceiver. For example, 802.11, a very well-known digital wireless standard currently commonly deployed in varying standards, would require that receiving device 100 utilize transceiver circuitry for its wireless circuitry 4. This wireless technology requires that there be a confirming signal transmitted by the receiving device to the transmitting device on a periodic basis.

So-called “Bluetooth” wireless technology, which is also a very well known digital wireless standard currently commonly deployed, similarly requires such a transmission by the receiving device.

Other varieties of wireless technologies do not require such a transmission by the receiving device (e.g., analog radio frequency transmissions). In such cases, wireless circuitry 4 of receiving device 100 could be merely a receiver. Conversely, transmitting device 200 would, in such cases, not need transceiving circuitry but would rather only need transmitting circuitry. However, ideally transmitter 200 and receiver 100 both maintain transceiver functionality.

The present invention contemplates multiple potential wireless standards. The advantage of using a digital wireless standard like 802.11, however, includes: (a) higher quality of transmission from transmitting device 200; (b) reduced loss of information transmitted or transceived; (c) reduced interference from other devices operating on the same or nearly the same radio frequencies; and (d) the ability of transmitting device 200 to identify a particular receiving device and transmit and receive from that one device as opposed to any other proximately-located device (for example, a transceiving device can indicate to its user that it has developed a wireless connection with a receiving unit named “Alpha 1,” which the user knows to be the receiving unit located in his or her cassette deck unit).

Accordingly, the preferred embodiment of the invention incorporates a digital wireless standard now developed or developable in the future for its wireless technology, such as 802.11.

Once audio information is received by the receiving device 100 from transmitting device 200 by the wireless circuitry 4 and components in receiving device 100, audio processor/codec 5 processes the signal received. Depending on the wireless standard being used and on whether digital or analog formats are employed, and whether compressed or uncompressed signals are being transmitted, audio processor/codec 5 can do any or all of the following tasks: (a) convert digital audio signals to analog signals, (b) uncompress digital audio information or (c) provide audio enhancement to the audio signal.

Once the audio signals of audio device 300 transmitted by transmitting device 200 are received and processed by the receiving device 100, they are then delivered through a magnetic head 19 of a cassette deck 400, to amplifier 18 and then to speakers or other output devices 16, in audio playback device 500, illustrated in FIG. 4. This is accomplished through the use of an emulator 3 located in receiving device 100 that abuts playback head 19 of the cassette deck.

As illustrated in FIG. 4, when supplied with audio signals, emulator 3 outputs the audio signals to cassette playing head 19 in a form that simulates the playing of a standard cassette tape, including both left and right channels of audio which may be output by audio device 300. The preferred embodiment further includes an accommodation for “auto-reverse” cassette decks. The development and operation of emulators and solutions for auto-reverse cassette decks is well known in the field and in addition is described in U.S. Pat. No. 4,734,897.

This invention thereby permits a user to play audio content from a digital or analog audio device (e.g., portable CD player, MP3 player, etc.) 300 through a conventional car, home or other stereo device and to control the audio output, including play, last/next, fast forward/rewind and pause functions, from audio device 300 without being connected to the output device with a wire and without needing to include a power source for the receiver.

In addition to providing a convenient means for listening to stored audio content via cassette deck 400 of a car or portable radio, the system also is able to support the recordation of music back through transmitter device 200 to audio device 300. As illustrated in schematic diagram FIG. 4, an audio device 17 is in communication with cassette recording head 20 of cassette deck 400, as is typical in most car and portable radios.

Also, as noted above, transmitting device 200 and receiving device 100 are contemplated both as transceiving devices, capable of both sending and receiving information. Thus, for example, if a user was listening to the radio (audio device 17) and desires to record the program, the user could engage cassette recording head 20 of cassette deck 400, which in turn transmits the information back through emulator 3 of receiving device 100. After transmission from wireless transceiver 4 in receiver 100 to transmitting device 200, the program data is sent through to audio device 300 via transfer plug 9/9A, which in turn records the radio program. It is understood that cassette deck 400 may incorporate its own wireless technology and, during a recording function on audio device 300, may be configured to send the wireless audio signal directly to transmitter 200, thereby by passing the need for receiver 100 to transmit generate and send the wireless signal.

Although the invention has been described in conjunction with specific embodiments thereof, and in some cases some (but not all) of the possible alternatives have been described, it is evident that many alternatives, modifications and variations will be apparent to those skilled in the art. Accordingly, this description is intended to encompass all such alternatives, modifications and variations that fall within the spirit and scope of this invention.

What is claimed is:

1. A system for playing audio files, said system comprising:
an audio device for storing and playing audio files;
a transmitter device, coupled to said audio device for receiving audio signals from the audio device and converting them into a wireless audio signal; and
a receiving device, configured to receive said wireless audio signal and converts it back to said audio signal, wherein said receiving device is further arranged to, couple with a preexisting audio playback device such that said audio signal can be played through the speakers of the preexisting audio device.
